(19) United States
(12) Patent Application Publication
(10) Pub. No.: US 2011/0010186 A1
(43) Pub. Date: Jan. 13, 2011

(54) METHOD AND SYSTEM FOR THE ADMINISTRATION OF ALTERNATIVE RISK FINANCE VEHICLES

(76) Inventors: Gary L. Mashore, Las Vegas, NV (US); Colin Moulton, Las Vegas, NV (US); James Leftwich, Henderson, NV (US)

Correspondence Address: DERGOSITS & NOAH LLP, Three Embarcadero Center, Suite 410, SAN FRANCISCO, CA, 94111, US

(21) Appl. No.: 12/617,629

(22) Filed: Nov. 12, 2009

Related U.S. Application Data
(60) Provisional application No. 61/223,518, filed on Jul. 7, 2009.

(51) Int. Cl. G06Q 40/00; G06Q 50/00

(52) U.S. Cl. 705/2; 705/4

(57) ABSTRACT

The invention is a system and method for managing and processing workers' compensation claims. After enrolling in the system, all communications regarding the reporting of a workplace injury pass through a management system on a computer server. The server tracks claims between different entities, including the policy holder, medical providers and third party administrators, and provides notifications of the existence and status of claims between the different entities. The server also compiles data from multiple claims in order to assess the efficiency of a workers' compensation policy. Recommendations and training may be provided based upon the server's analysis of the compiled data.

### CROSS-REFERENCE TO RELATED APPLICATIONS

This patent application claims priority under 35 U.S.C. §119(e) to provisional U.S. Patent Application No. 61/223,518, filed on Jul. 7, 2009, and incorporated in full herein.

### FIELD

The invention relates generally to alternative risk financing, and specifically, to a system and method for processing and assessing the efficiency of a workers' compensation policy.

### BACKGROUND

One of the most significant costs for a business involves dealing with insurance costs for its workers. This can include the time and cost to locate and enroll in a suitable insurance policy for the workers. Specifically, workers' compensation policies are a required cost of doing business, but businesses often lack the time and resources to effectively manage a workers' compensation policy for its workers. As a result, this task is often outsourced to third party administrators that coordinate the workers' compensation policy. However, this is not always a cost-effective solution.

The administration of a workers' compensation plan or policy requires coordination between multiple entities in order to ensure that claims are properly assessed and timely recompensed. These entities include the policy holder (e.g., the business and its workers), the third party administrator (TPA), the medical providers and the insurer. While at present, much of this coordination may be manually performed, it would be preferable to automate some or all of the policy administration. Automation would optimize administration of the policy and would promote quick resolution of workers' compensation claims. It would also be preferable if the different entities could interface claim documents, regardless of which entity produced or approved a document. Such access would provide all entities with valuable information on whether a policy is being effectively administered, and the status of various claims. In addition, it would be advantageous to implement a system for evaluating the efficiency of the workers' compensation policy. A policy holder would be interested to know whether its current policy is appropriately covering the policy holder's needs. Also, a policy holder would be interested to know how it might be able to reduce policy costs, while at the same time promoting a safer work environment. Such information would help convince a policy holder whether it makes sense to renew the policy at the end of each policy term.

Policy efficiency is also an area that requires significant improvement. Current insurance policy information is reactive, in that health professionals react by providing treatment when an injured worker is presented, claim adjusters review claims after submission from treating physician, and reimbursements are not disbursed until after claims are reviewed and the worker is back to work. It would therefore be advantageous to have the ability to notify physicians when to expect an injured worker. Claim adjusters would appreciate knowing when to expect data relevant to a claim before the claim is submitted. Health professionals would also appreciate timely payments soon after an injured worker is treated.

What is therefore needed is a workers' compensation management system that will provide entities with access to information about claim resolution and policy efficacy. What is further needed is a worker's compensation management system that provides predictability to entities using the system, so that injured workers are quickly treated and health professionals are reimbursed for rendered services in a timely manner.

### BRIEF DESCRIPTION OF THE FIGURES

The invention is illustrated by way of example and not limitation in the figures of the accompanying drawings, in which like references indicate similar elements, and in which:

FIG. 1 is an exemplary block diagram depicting an embodiment of the invention.

FIG. 2 is an exemplary flow diagram illustrating the steps of an embodiment of the invention.

FIG. 3 is an exemplary flow diagram illustrating the steps of an embodiment of the invention.

FIG. 4A is an exemplary screenshot of an incident report, according to an embodiment of the invention.

FIG. 4B is an exemplary screenshot of markup language, according to an embodiment of the invention.

FIG. 5 is an exemplary screenshot of a display of an embodiment of the invention.

FIG. 6 is an exemplary screenshot of a display of an embodiment of the invention.

### DETAILED DESCRIPTION

The invention is a system and method for efficiently processing reimbursement claims. In the examples discussed herein, the invention is described in the context of managing workers' compensation claims in accordance with a workers' compensation policy. For example, the invention may be used to administer self-insurance groups, mutual benefit corporations, municipal risk pools, joint powers authorities, captives, risk retention groups, and the like. However, one will appreciate that the invention may be used to administer other risk finance vehicles in order to control costs and improve work flow between different entities.

It should be appreciated that the invention can be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

In the context of this document, a computer usable medium or computer readable medium may be any medium that can contain or store the program for use by or in connection with the instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing the invention. Applications may also be downloaded in whole or in part through the use of a software development kit or toolkit that enables the creation and implementation of the invention. In this specification, these implementations, or any other form that the invention may take, may be referred to as techniques. In general, the order of the steps of disclosed processes may be altered within the scope of the invention.

### Connections Management System

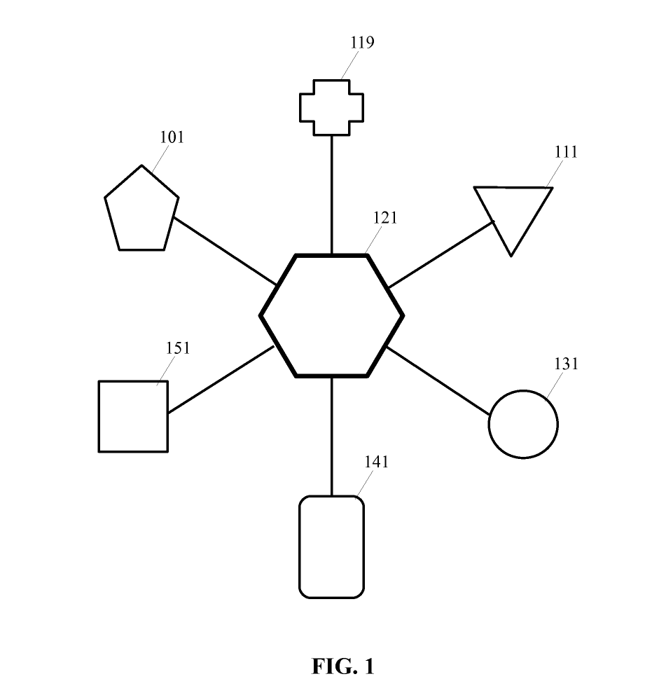

FIG. 1 is a block diagram illustrating how an embodiment of the invention interacts with various entities. Each entity may have an associated database for storing data transmitted during interacts or transactions. These entities may include a client 101, a nurse triage unit 119, a third-party administrator (TPA) 111, a healthcare provider 131, a medical laboratory 141, and a bank 151. One will appreciate that client 101 may vary in identity depending upon the context in which the invention is applied, so long as client 101 is the originator of requests for services from the other entities. For example, if the invention is used to process workers' compensation claims, client 101 may be an employer, a workplace or a collection of workplaces. If the invention is used to process insurance claims, client 101 may be a member or subscriber or a collection of members of the insurance plan. Client 101 may represent an insured member of a self insurance group (“SIG”) or may represent an entire self insurance group, mutual benefit corporation, municipal risk pool, joint powers authority, captive, risk retention group, and the like.

In FIG. 1, a management system 121 interacts with all of these entities over a network, acting as a liaison or communications link between the other entities. Management system 121 may have an associated database for storing data, which may either be data for management system 121 or data for the entities. In an embodiment, management system 121 provides a single store of data for populating forms used by each entity.

Management system 121 may communicate with each entity using a secure Internet connection or other network connection that incorporates secure protocols and/or encryption to prevent accidental disclosure of private medical information or other confidential data. Such secure information may include financial data, policy data, sales data, medical data, personal data, employment history data, claims data or demographic information that may be stored in one or more of the databases associated with each entity in FIG. 1, or management system 121. One will appreciate that the entities shown in FIG. 1 are merely exemplary, and that other entities may communicate with those shown in FIG. 1 through management system 121. One will also appreciate that there may be multiple clients 101, nurse triage units 119, TPAs 111, etc., all of which may be managed by management system 121.

Enrollment/Underwriting

As previously mentioned, management system 121 may be associated with a database containing data for populating forms used by the other entities of FIG. 1. In an embodiment, this data is collected when a client 101 is first enrolled with management system 121. In the insurance or workers' compensation context, this may also be known as the underwriting or application process.

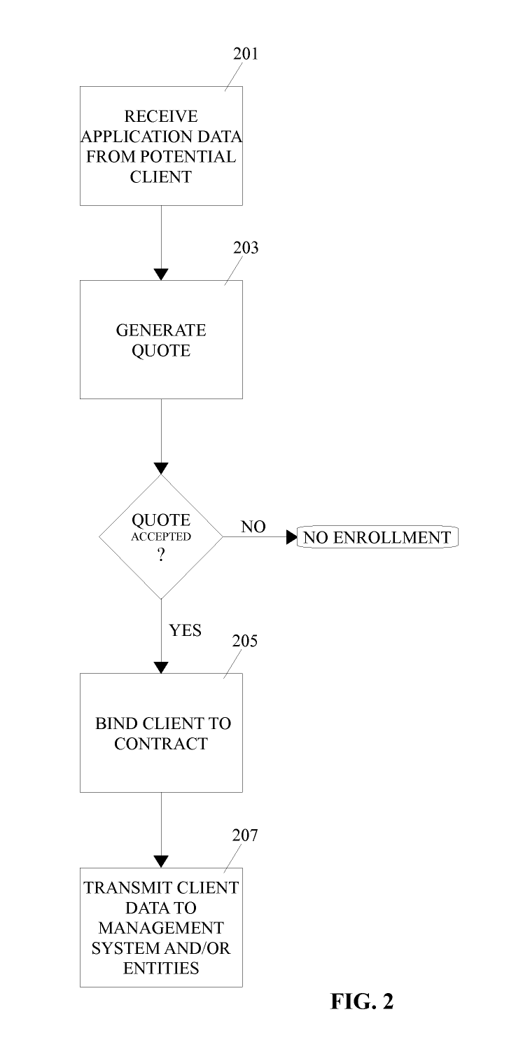

FIG. 2 is an exemplary flow diagram of an enrollment process. In block 201, management system 121 receives an application from a potential client. The application may be received through an online web form, facsimile, or by written request. One will appreciate that if an application is received by facsimile, written request or other non-digital means, then data from the application will need to be inputted into a form readable by management system 121. As will be discussed further below, the format for the application form and other forms may be in a computer-readable markup language, such as XML.

Application form data may include information fields that may be useful for future forms used by entities. For example, the application form may include a legal name for the applicant, a classification for the applicant (e.g., individual, corporation), a state identification number of the applicant (e.g., social security number, driver license number or corporate license number), a start date, a list of corporate officers, an identification number for the preparer of the application form if prepared by an insurance broker or other licensed professional, a Standard Industry Class (“SIC”) code, contact information, safety contact information, account information, and the like.

One will appreciate that the above information is used to determine an estimated policy premium, or quote, for the applicant using conventional actuarial or underwriting methods (block 203 of FIG. 2). The quote may also consider an on-site inspection of the applicant's workplace, as well as other information indicative of risk. Once a quote is generated for the applicant, it is presented to the applicant for acceptance or rejection (block 205 of FIG. 2). If the applicant rejects the quote, then the enrollment process ends and no further action is taken. However, if the applicant accepts the quote, then in block 205, the quote becomes a binding contract. In FIG. 1, applicant may be represented as client 101 after acceptance of the quote. One will appreciate that the enrollment process may also involve the exchange of funds and payment of an insurance premium, which may be deposited into an account held by bank 151 of FIG. 1.

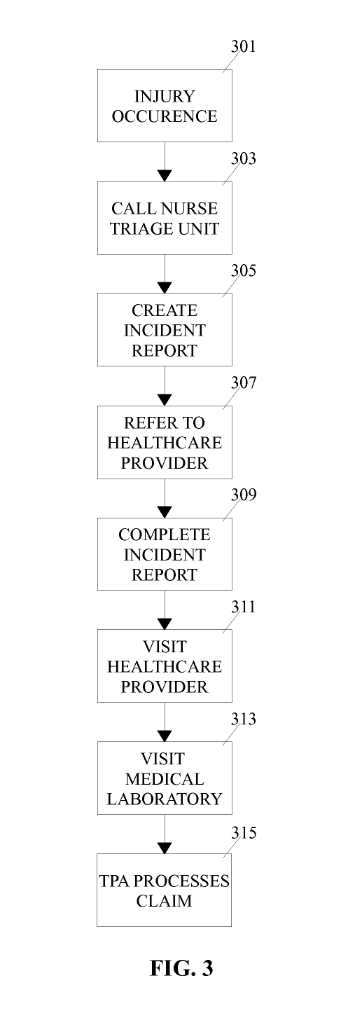

As previously mentioned, the application process involves the input of data in XML or other computer-readable format into a database associated with management system 121 of FIG. 1. In block 207 of FIG. 2, a portion of the data for client 101 may then be transmitted to each of the entities shown in FIG. 1. One will appreciate that the data transmitted to one affiliated entity may differ from the data transmitted to another affiliated entity. One will also appreciate that data may not be transmitted to each affiliated entity, but an entity may request data from or gain access to data through management system 121 whenever necessary. For example, nurse triage unit 119 may not have any information for a member of client 101 until the member contacts nurse triage unit 119 to report an injury incident. The process for reporting and managing an injury incident and resulting insurance claim is described further below and illustrated in FIG. 3. In another example, portions of data from management system 121 may be regularly transmitted to each of the entities of FIG. 1 to ensure that each entity is updated with the most recent information for client 101.

### Processing a Workers' Compensation Claim

FIG. 3 is an exemplary flowchart of a claim resolution process, from the initial reporting of an injury incident, to filing of an insurance claim, to final payment of medical expenses for treatment of the injury, to closing of the claim. In the example described herein, the reported injury is an injury that occurs at a workplace, and client 101 is the insured employer or workplace. If the injury falls outside state first aid guidelines, or if the injury requires treatment by a healthcare provider, then the reported injury may require filing of an insurance claim, or workers' compensation claim. Resolution of the claim may include the injured worker's return to work and/or payment to one or more healthcare providers. One will appreciate that the following process may also apply to claims other than workers' compensation claims, and that the following example is not intended to limit the scope of the invention. In the following example, reference to client 101 includes a person located at client 101 or a representative of client 101.

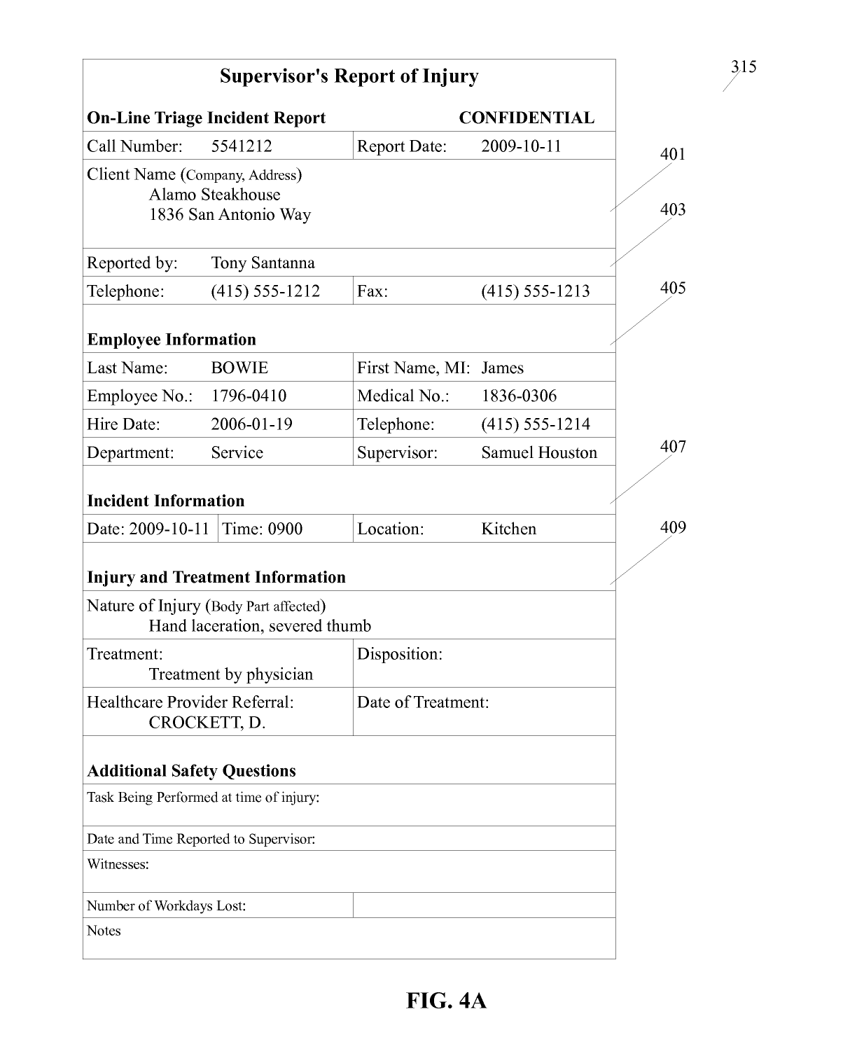

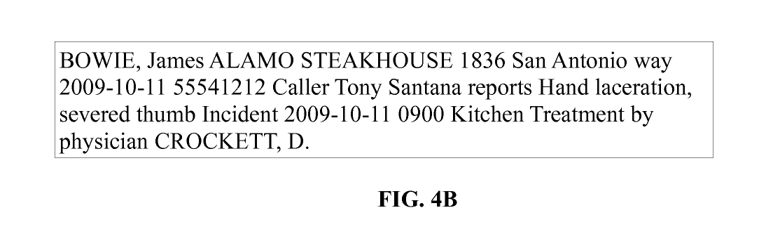

In block 301, the process of FIG. 3 is initiated with the occurrence of an injury at client 101. In block 303, client 101 places a telephone call to nurse triage unit 119 to describe the injury and the circumstances of the injury. In block 305, nurse triage unit 119 creates an incident report based upon the information relayed by client 101. FIG. 4A is an exemplary incident report that includes data supplied to nurse triage unit 119, as well as information supplied through or by management system 121. One will appreciate that the format of the incident report may change, as well as the information included with the incident report, and that FIG. 4A is not meant to limit the invention in any way.

The incident report of FIG. 4A includes information for client 101 in box 401. This may include location information, and account number, and the like. Box 403 may include information on the person who contacted nurse triage unit 119. This may be important for follow up information, especially if the injured worker that prompted the incident report is unable to speak or if translation services are required. Information for the injured worker may be presented in box 405. This may include contact information for the injured worker and other identifying information for the injured worker. Box 407 may include information about the incident itself, including the time the incident occurred, the circumstances of the incident, a description of the sustained injury, and the like. Box 409 may include suggested actions and follow up information. If a healthcare provider identified for future treatment, this information may be included as well.

Nurse triage unit 119 may serve as a source of first line treatment and medical advice for the injury reported by client 101. In lieu of providing medical advice over the phone, nurse triage unit 119 may refer client 101 to one or more affiliated healthcare providers 131 (block 307). If client 101 confirms that treatment will be sought from one of the affiliated healthcare providers 131, then nurse triage unit 119 may record this confirmation in the incident report. In an embodiment, nurse triage unit 119 may connect client 101 with a selected healthcare professional 131 so that client 101 does not need to make another phone call, and so that medical attention is promptly sought.

One will appreciate that a feature of the invention is the availability of data about client 101 as aggregated by management system 121 and transmitted to nurse triage unit 119. The type of data aggregated by management system 121 is discussed in more detail in the following section. In the context of claim resolution process, when client 101 contacts nurse triage unit 119 to report an incident, client 101 may initially provide identification information so that nurse triage unit 119 can access account information for client 101. The account information may include data gathered during the enrollment process of FIG. 2. The account information may include data gathered from other incident reports or any other information previously received from or gathered about client 101. Once nurse triage unit 119 verifies the identity of client 101 and locates account information for client 101, nurse triage unit 119 will be able to create a digital incident report without having to repeat the process of gathering account information for client 101 since this information will already populate the digital incident report. In other words, nurse triage unit 119 can concentrate on advising treatment and providing a referral to an appropriate healthcare provider 131 for the injury, rather than gathering additional information on client 101. In the exemplary incident report of FIG. 4A, this may mean that nurse triage unit 119 need only fill out the information for boxes 407 and 409, since boxes 401, 403 and 405 may be automatically populated as soon as client 101 is identified. One will appreciate that this step may be further automated if client 101 is identified using caller ID or some other automated identification method.

Returning to the process illustrated in FIG. 3, nurse triage unit 119 completes the incident report and saves the incident report in a database accessible by management system 121 (block 309). The incident report may also be transmitted over the network to management system 121. In an embodiment, client 101 may create an incident report without contacting nurse triage unit 119. In this embodiment, client 101 may access a web-based form by logging into a secure account. Client 101 may then enter in the information for the incident using the web-based form, which will then be saved in a database accessible by management system 121. Even though client 101 may report the incident directly to management system 121, it may be preferable that incident reporting be handled by nurse triage unit 119, since nurse triage unit 119 may recommend medical care for treatment of the reported injury. In either embodiment, in block 309 of FIG. 3, management system 121 may be alerted that a new incident report has been added to the system.

As discussed herein, FIG. 4A is an exemplary incident report that may be used in the claim resolution process. FIG. 4B is a screenshot of exemplary XML that may populate an incident report and for use by entities affiliated with management system 121. One will appreciate that the data used to populate the incident may also be used to populate an insurance claim form, which may be filed by the injured employee's employer (client 101), or may be submitted by the injured employee. The incident report may ripen into an actual claim when a party seeks reimbursement in connection with the injury, such as medical expenses or paid leave.

As discussed above and illustrated in FIG. 1, management system 121 may serve as a liaison to a number of entities involved in the treatment and resolution of insurance claims. Because management system 121 is interconnected with all of the entities that form part of the claim resolution process, management system 121 can provide an early warning system to other entities once an incident report has been added to the system. For example, the incident report will identify the type of injury reported by client 101. The injury may require treatment by a specific healthcare provider 131 affiliated with management system 121. Management system 121 may send an alert or notification to healthcare provider 131 so that healthcare provider 131 may anticipate seeing the injured worker. At the time healthcare provider 131 sees and treats the injured worker, healthcare provider 131 will have all of the relevant account information for the injured worker, since healthcare provider 131 will have received it from management system 121 or may access the account information using an online form or web interface for management system 121.

In block 311 of FIG. 3, the injured worker from client 101 seeks medical treatment from healthcare provider 131, who may require that the injured worker visit a medical laboratory for blood tests or other tests. As shown in FIG. 1, there may be one or more affiliated laboratories 141 that healthcare provider 131 can suggest. Preferably, the injured worker from client 101 will go to an affiliated laboratory 141 (block 313 of FIG. 3), which will be alerted to the injured worker's visit and will already have all of the relevant information about the worker's injury and account information by virtue of having access to data from management system 121. As discussed above, laboratory 141 may also receive the benefit of the early warning system provided by management system 121. In addition, once the laboratory 141 has received laboratory results for the injured worker from client 101, these results may be transmitted to healthcare provider 131 for review. In an embodiment, healthcare provider 131 may receive a notification from management system 121 or laboratory 141 that laboratory results are available for the injured worker from client 101, and the healthcare provider 131 can access these results using a secure website or other method.

One aspect common to many claims resolution processes is compensating the healthcare provider and/or the medical laboratory for provided services. This may be handled by a TPA that will typically receive a paper form from a healthcare provider once treatment has been rendered. As a result, payment to the healthcare provider may often be delayed, resulting in an unsatisfactory experience for the healthcare provider. The invention avoids delay by providing digital processing of submitted claims. In block 315 of FIG. 3, TPA 111 automatically receives the information necessary for compensating healthcare provider 131 as soon as healthcare provider 131 completes a report on the treatment of the injured worker from client 101. In an embodiment, TPA 111 may be alerted to expect a claim from either healthcare provider 131 or laboratory 141 as soon as nurse triage unit 119 completes an incident report and notes which healthcare provider 131 will treat the injured worker from client 101. In this fashion, TPA 111 also receives the benefit of the early warning system provided by management system 121.

In an embodiment, management system 121 may track the claim resolution process for client 101. For example, management system 121 may enforce a timeline for completion of certain tasks. Upon receipt of an incident report or upon notification that an incident has been reported, management system 121 can periodically contact client 101 to ensure that the injured worker has received medical treatment from a healthcare provider. One will appreciate that the injured worker does not necessarily need to seek treatment from an affiliated healthcare provider 131 or use an affiliated laboratory 141. In either of these situations, management system 121 may still follow up with client 101 to ensure timely treatment and payment for treatment. However, if the injured worker uses the services of affiliated entities, then the claim resolution process may be easier to track, and the appropriate entities may be compensated by a TPA in a more efficient and timely manner. As will be discussed further below, there are various ways that management system 121 may track and follow up with client 101, including a visual display, web interface, email communications and the like.

### Data Aggregation

One will appreciate that each of the blocks in FIG. 3 may result in the generation of data that is reported to and aggregated by management system 121. Over time, management system 121 may store sufficient data to assess how often injuries occur at client 101, the types of injuries treated by nurse triage unit 119 for the workers at client 101, the types of laboratory tests performed by laboratory 141 for the workers at client 101, the types of workers' compensation claims handled by TPA 111 for the workers at client 101, etc. The aggregated data may be used to assess how safe client 101 is and whether or not training may be warranted to prevent certain injuries. The data may also be used to assess whether nurse triage unit 119 provides adequate care to the workers of client 101. The data may also identify whether all of the laboratory tests performed by laboratory 141 are sufficiently informative or necessary. Additionally, the data may identify whether or not the TPA 111 efficiently handles workers' compensation claims, or if it lags in providing compensation to injured workers and/or client 101. In sum, multiple performances of the processes disclosed herein may result in a large amount of information that can determine how efficiently workers' compensation claims are handled, and how appropriate the premiums are for the workers' compensation policy provided to the client 101. Therefore, the invention is not only an efficient way to manage workers' compensation claims, but also, the invention is a way to evaluate the level of service provided to client 101.

### Display and Notifications

In an embodiment, the data aggregated by management system 121 may be accessed using a web browser, or otherwise packaged for display. Each entity may access a customized web page at a central web address, such as www.MyCHSI.com, which is owned and managed by the assignee of the invention. For example, client 101 may be able to track a single claim, or multiple claims, to ensure each one is timely resolved. Client 101 may also see if premiums are timely paid, or the status of the policy. Client 101 may also use a web interface to make changes to a policy.

In another example, nurse triage unit 119 may have access to a web interface for viewing account information about injured workers who have called nurse triage unit 119. The web interface may be interactive in displaying specific healthcare providers 131 or laboratories 141 that can handle the specific injuries suffered by an injured worker. Similarly, TPA 111 may also have access to a web interface that contains all of the information necessary for processing a claim from client 101, including the incident report, treatment summaries and invoices from healthcare provider 131, and/or laboratory results from laboratory 141. In sum, each entity may view some or all of the information generated from one or more claims.

Because management system 121 may access a central repository or data store for all the aggregated data, management system 121 may provide additional display capabilities that will enable analysis of claim resolution performance and may take advantage of the volume of aggregated data. For example, management system 121 may be used to manage multiple clients across a wide geographic area. Each client may in turn have multiple workplaces. Management system 121 may be able to display on a map each of the workplaces for a client, as well as all of the clients managed by management system 121. The map display may include color-coded or shape-specific markers for each client, so that each client can be readily distinguished from another on the map display. Further, each time an incident is reported, the map display can display an icon or other symbolic representation at the location of the incident so that these locations can be readily identified. In addition, if there is a specific timeline requirement from the time an incident is reported to the time the incident should reach a milestone, the displayed icon can have a concurrent time component, such as changing color over time or having a time-based counter. In this fashion, management system 121 can provide data for display that not only displays a geographic component, but a time-based component as well.

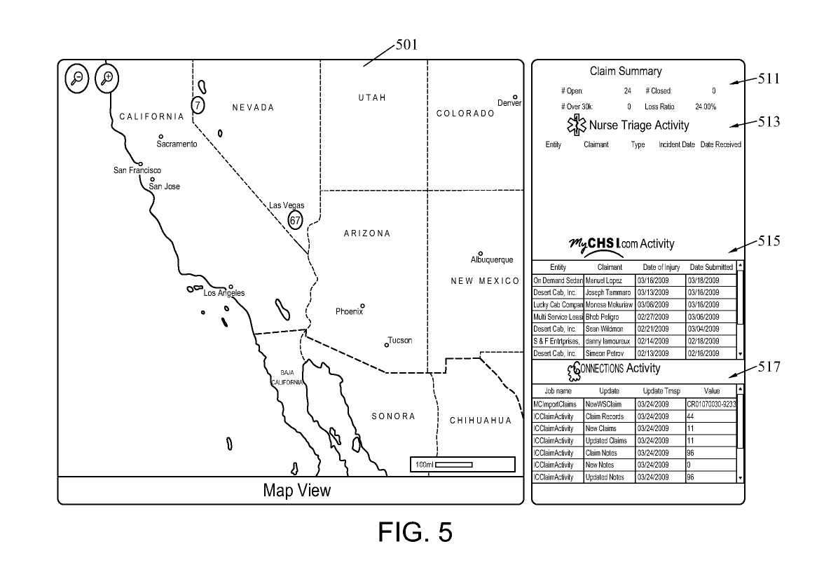

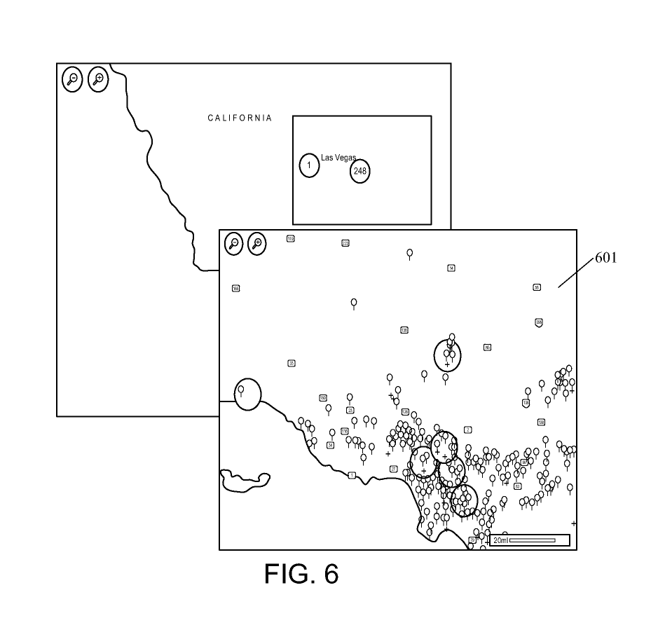

An embodiment of a time-based geographic display is depicted in the screenshot of FIG. 5. FIG. 5 includes a map 501, and various data components, such as claim summary 511, nurse triage activity 513, web activity 515 and system activity 517. Map 501 may include an interactive display of a portion of the geographic area managed by management system 121. One will appreciate that map 501 may be zoomed in for added detail on a specific geographic area. For example, FIG. 6 includes a zoomed in portion of map 501 from FIG. 5. The zoomed in portion 601 displays various icons, markers or pins denoting the location where an incident occurred and was reported. One will appreciate that the number of incidents at a location may be shown as a number. One will also appreciate that the color of the pin may denote the length of time that has passed since an incident occurred. For example, the pin may be green if the incident occurred one day ago, yellow if the incident occurred two days ago, or red if the incident occurred three days ago. Pins may also flash or be shown with other visual indicators denoting time. One will appreciate that a concurrent time and location display may be important for workers compensation, since after a certain amount of time has passed after occurrence of an incident; the claim may have to include compensation for work time lost. As such, it may be important to track such incidents to identify which incidents may require work time lost compensation in order to expedite claim resolution and return the injured worker to work. One will appreciate that the time display may differ depending upon the geographic location shown. For example, incidents which occur in California may show a different time display than Nevada to reflect the different time cutoffs for work time lost accrual.

Returning to FIG. 5, claim summary 511 may show information on how many claims are currently pending, how many are resolved or closed, and how many may exceed a certain dollar amount. Nurse triage activity 513 may display information on one or more clients that have contacted nurse triage unit 119 to report an incident. Web activity 515 may display information on incident reports or claims filed using a web interface. System activity 517 may display information on claims received by management system 121 through other channels, such as through TPA 111. One will appreciate that the information shown in FIGS. 5 and 6 are merely exemplary, and that other information accessed by management system 121 may be displayed without departing from this disclosure of the scope of the invention.

FIGS. 5 and 6 represent exemplary displays of how incidents and subsequent claims may be visually tracked by management system 121. An administrator or user having access to any one of these displays may be able to quickly assess the performance of management system 121 with regards to client safety, incident reporting and claim resolution.

One will also appreciate that any of the displays produced using data accessed by management system 121 may be fully interactive. For example, selecting any one of the pins in FIG. 6 may bring up additional details on a location, the incident reports filed at that location, the types of injuries at that location, as well as individual incident reports from that location. Similarly, selecting any of the individual incidents or claims displayed in nurse triage activity 513, web activity 515 or system activity 517 of FIG. 5 may bring up additional details for the selected incident report or claim.

### Policy Renewal

A client may wish to renew its policy according to a schedule enumerated in the policy contract. A policy may be reviewed and renewed annually, semi-annually, bi-annually, etc. Calculating a new policy premium may follow any conventional actuarial method or other known method practiced in the industry. However, the policy premium and terms may consider the data aggregated from the client's use of the management system 121. For example, there may be a discount applied or other incentive applied if the client judiciously reports incidents by calling the nurse triage unit. In another example, since management system 121 tracks incidents and claims, a policy premium may be adjusted if the client resolves claims quickly and employees avoid lost time claims.

One will appreciate that if the client wishes to add workplace or employee coverage, or edit the information stored for the client, such changes may be quickly entered and stored by access to management system 121. In this fashion, changes to a client's policy or contact information may be quickly disseminated to all affiliated entities without affecting claim tracking or claim resolution. In addition, this ensures that affiliated entities have the most current information available for claims.

In the description above and throughout, numerous specific details are set forth in order to provide a thorough understanding of the invention. It will be evident, however, to one of ordinary skill in the art, that the invention may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of the invention. One will appreciate that these steps are merely exemplary and are not meant to be limiting in any way. Other steps and functions may be contemplated without departing from this disclosure or the scope of the invention.

What is claimed is:

1. A method comprising:
receiving, by a server computer, an injury incident report created by a nurse triage unit, wherein the injury incident report includes information about an injury and previously stored information about a person receiving the injury;
providing at least one healthcare provider for treating the injury, wherein the at least one healthcare provider has access to the received injury incident report;
receiving, by the server computer, a request for reimbursement from the at least one healthcare provider after treating the injury; and,
transmitting, by the server computer, the request for reimbursement to a third party administrator.

2. The method of claim 1, further comprising displaying, on a display, a portion of the information from the injury incident report.

3. The method of claim 2, wherein displaying the portion of the information includes displaying a geographic location of the injury.

4. The method of claim 1, further comprising:
upon receipt of the injury incident report by the server computer, monitoring for completion of a deadline, the deadline selected from a group consisting of a time interval between a reported injury and treatment by a healthcare professional, a time interval between treatment by the healthcare professional and a claim for reimbursement from the healthcare professional, a time interval between the reported injury and a return to work;
storing, by the server computer, a time interval for completion of the deadline; and,
if the completion of the deadline is not within the stored time interval, then generating a notification by the server computer.

5. The method of claim 4, further comprising displaying, by the server computer, the time interval for completion of the deadline.

6. A method comprising:
monitoring for completion of a deadline upon receipt of an injury incident report by a server computer, the deadline selected from a group consisting of a time interval between a reported injury and treatment by a healthcare professional, a time interval between treatment by the healthcare professional and a claim for reimbursement from the healthcare professional, a time interval between the reported injury and a return to work;
storing, by the server computer, the time interval for completion of the deadline; and
calculating a service premium based upon time interval for completion of the deadline.

7. The method of claim 6, further comprising displaying, by the server computer, the time interval for completion of the deadline.

8. The method of claim 7, further comprising displaying, on a display, a geographic location of the reported injury.

9. A system comprising:
a nurse triage unit for receiving an injury incident report that reports an injury;
a healthcare professional for reviewing the incident report and providing treatment for the reported injury;
a medical laboratory for reviewing the incident report and providing a laboratory result for the reported injury;
a third party administrator for managing reimbursement of an insurance claim for the treatment of the reported injury; and
a server computer for monitoring the progress of insurance claim.

10. The system of claim 7, wherein the server computer further displays information from the nurse triage unit, the healthcare professional, the medial laboratory, or the third party administrator.

11. The method of claim 10, wherein a display displays a geographic location of the injury.
